(19) United States
(12) Patent Application Publication
(10) Pub. No.: US 2025/0036927 A1
(43) Pub. Date: Jan. 30, 2025

(54) COMPUTING SYSTEM FOR PROCESSING NEURAL NETWORK AND METHOD OF OPERATING THE SAME

(71) Applicant: SK hynix Inc., Gyeonggi-do (KR)

(72) Inventor: Seok Min LEE, Gyeonggi-do (KR)

(21) Appl. No.: 18/407,469

(22) Filed: Jan. 9, 2024

(30) Foreign Application Priority Data
Jul. 26, 2023 (KR) 10-2023-0097281

(51) Int. Cl. G06N 3/0495

(52) U.S. Cl. CPC G06N 3/0495

(57) ABSTRACT

Provided herein may be a computing system and method of operating the same. The computing system may include an operating component including at least one convolution block, and a controller configured to control the operating component to perform convolution operations, wherein the at least one convolution block includes a first convolution layer configured to perform a first convolution operation on input data based on a 1×1 kernel to generate first result data, a second convolution layer configured to perform second convolution operations on 10 respective channels of first result data based on an n×n kernel, where n is a natural number of 2 or greater, and sum result values of the convolution operations to generate second result data, and a third convolution layer configured to perform a third convolution operation on the second result data based on the 1×1 kernel to generate final result data.

### CROSS-REFERENCE TO RELATED APPLICATION

The present application claims priority under 35 U.S.C. § 119 (a) to Korean patent application number 10-2023-0097281 filed on Jul. 26, 2023, the entire disclosure of which is incorporated by reference herein.

### BACKGROUND

### 1. Field of Invention

Various embodiments of the present disclosure generally relate to a semiconductor device, and more particularly to a computing system for processing a neural network and a method of operating the computing system.

### 2. Description of Related Art

A neural network may utilize artificial neurons obtained by simplifying the functions of biological neurons, and these artificial neurons may be interconnected through a connection line having a connection weight. The connection weight (i.e., the parameter of the neural network) may be a specific value of the connection line and may also be referred to as “connection strength.” The neural network may perform human cognitive functions or learning (or training) processes through artificial neurons. Training the neural network may be understood as training the parameter of the neural network. Further, the trained neural network may be understood as a neural network to which the trained parameter is applied. Each artificial neuron may also be referred to as a “node.”

A convolution operation may occupy a significant portion of operations required in a neural network model. The convolution operation may be performed through a multiply-accumulate (MAC) operation device implemented as a storage area in which a plurality of cells are formed in an array structure. When a depth-wise convolution operation, which is one of convolution operations, is applied to the multiply-accumulate (MAC) operation device, cell utilization may be decreased. Therefore, a neural network architecture that is capable of increasing cell utilization is desirable.

### SUMMARY

Various embodiments of the present disclosure are directed to a computing system capable of improving neural network processing performance, and a method of operating the computing system.

An embodiment of the present disclosure may provide for a computing system. The computing system may include an operating component including at least one convolution block configured to perform convolution operations on input data based on weight data to generate final result data, and a controller configured to control the operating component to perform the convolution operations, wherein the at least one convolution block includes a first convolution layer configured to perform a first convolution operation on the input data based on a kernel of 1×1 size to generate first result data, a second convolution layer configured to perform second convolution operations on respective channels of the first result data based on a kernel of n×n size, and sum result values of the convolution operations on respective channels of the first result data to generate second result data, where n is a natural number of 2 or greater, and a third convolution layer configured perform a third convolution operation on the second result data based on the kernel of the 1×1 size to generate the final result data.

An embodiment of the present disclosure may provide for a method of operating a computing system for processing a convolution block including a plurality of convolution layers. The method may include performing, by a first convolution layer among the plurality of convolution layers, a first convolution operation on input data based on a kernel of 1×1 size to generate a first result data having a channel of a first size, performing, by a second convolution layer among the plurality of convolution layers, second convolution operations on respective channels of the first result data based on a kernel of n×n size, where n is a natural number of 2 or greater, summing, by the second convolution layer, result values of the second convolution operations on the respective channels in the second convolution layer to generate second result data having a channel of a second size, and performing, by a third convolution layer among the plurality of convolution layers, a third convolution operation on the second result data based on the kernel of the 1×1 size to generate final result data.

These and other features and advantages of the invention will become apparent from the detailed description of embodiments of the invention and the following figures.

### BRIEF DESCRIPTION OF THE DRAWINGS

Embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will convey the scope of the embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a diagram illustrating a computing system according to an embodiment of the present disclosure.

FIG. 2 is a diagram illustrating an operating component according to an embodiment of the present disclosure.

FIG. 3 is a diagram illustrating a convolution block according to an embodiment of the present disclosure.

FIG. 4 is a diagram illustrating a convolution operation in a second convolution layer according to an embodiment of the present disclosure.

FIG. 5 is a diagram illustrating a bottleneck structure according to an embodiment of the present disclosure.

FIG. 6 is a diagram illustrating an operation of mapping weight data according to an embodiment of the present disclosure.

FIG. 7A is a flowchart illustrating a method of determining the number of channels of first result data according to an embodiment of the present disclosure.

FIG. 7B is a diagram illustrating an operation of mapping weight data based on the determined number of channels of the first result data according to an embodiment of the present disclosure.

FIG. 8A is a flowchart illustrating a method of determining the number of channels of second result data according to an embodiment of the present disclosure.

FIG. 8B is a diagram illustrating an operation of mapping weight data based on the determined number of channels of the second result data according to an embodiment of the present disclosure.

FIG. 9 is a diagram illustrating a quantization operation according to an embodiment of the present disclosure.

FIG. 10 is a flowchart illustrating a method of operating a computing system according to an embodiment of the present disclosure.

### DETAILED DESCRIPTION

Specific structural or functional descriptions in the embodiments according to the concept of the present disclosure introduced in this specification are only for description of the embodiments according to the concept of the present disclosure. The embodiments according to the concept of the present disclosure may be practiced in various forms, and should not be construed as being limited to the embodiments described in the specification.

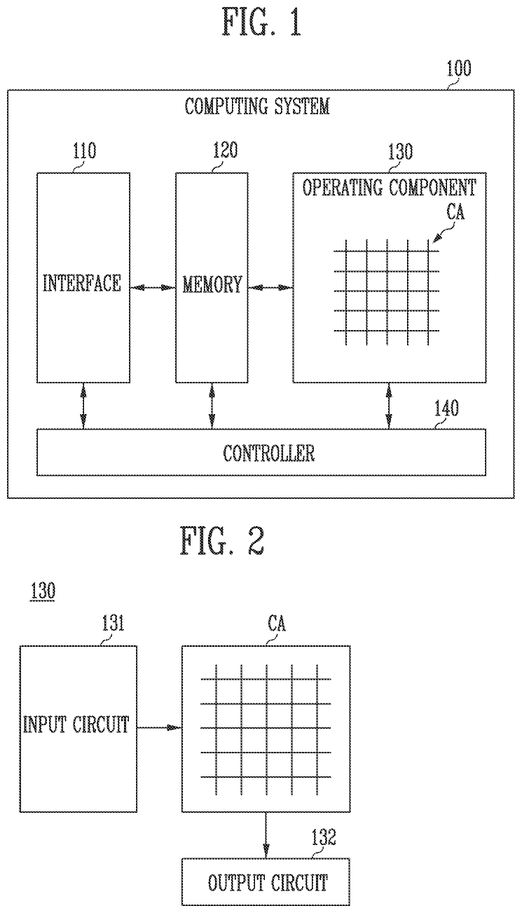

FIG. 1 is a diagram illustrating a computing system 100 according to an embodiment of the present disclosure.

Referring to FIG. 1, the computing system 100 may include an interface 110, a memory 120, an operating component 130, and a controller 140. In an embodiment, the interface 110, the memory 120, the operating component 130, and the controller 140 may communicate with each other through a communication bus.

In an embodiment, the computing system 100 may be a neural network dedicated hardware accelerator itself or a device including the hardware accelerator. For example, the computing system 100 may be a device capable of performing a weight stationary-based two-dimensional (2D) matrix multiplication operation.

In an embodiment, a neural network may be implemented as a deep neural network (DNN), a convolutional neural network (CNN), a recurrent neural network (RNN), or the like.

The interface 110 may perform communication with an external device. For example, the interface 110 may receive input data, weight data, etc. required for processing the neural network from the external device, or may transmit final result data provided from the operating component 130 to the external device.

The memory 120 may be a volatile memory or a nonvolatile memory, and may store instructions or program codes required for processing the neural network.

The operating component 130 may include a storage area CA for performing an operation.

In an embodiment, the operating component 130 may perform a convolution operation, for example, an element-wise multiply-accumulate (MAC) operation. The operating component 130 may provide the result of the MAC operation to the memory 120 or the controller 140.

The controller 140 may control operations of the computing system 100. The controller 140 may control the operations of the interface 110, the memory 120, and the operating component 130. For example, the controller 140 may set and manage parameters related to a neural network operation, for example, a convolution operation so that the operating component 130 may normally execute layers of the neural network.

The controller 140 may be implemented as hardware, software (or firmware) or a combination of hardware and software. In an embodiment, the controller 140 may be implemented as a hardware logic designed to perform the above-described functions. In an embodiment, the controller 140 may be implemented as at least one of various processors, such as a central processing unit (CPU), a microprocessor, and the like, and may execute a program including instructions or program codes constituting the above-described functions.

In an embodiment, the neural network may include at least one convolution block, for example, in the operating component 130. The convolution block may include a plurality of convolution layers forming a bottleneck structure. For example, one of the plurality of convolution layers may extract a feature map by summing result values of performing convolution operations on respective channels (i.e., channel-wise convolution operations) of input data based on a kernel of n×n size, where n is a natural number of 2 or greater. Each of the remaining convolution layers may extract a feature map by performing a convolution operation based on a kernel of 1×1 size. Here, the remaining convolution layers may be located before or after the one convolution layer in the order of the convolution operation.

FIG. 2 is a diagram illustrating the operating component 130 shown in FIG. 1 in detail according to an embodiment of the present disclosure.

Referring to FIG. 2, the operating component 130 may include an input circuit 131, an output circuit 132, and the storage area CA.

The input circuit 131 may apply input data to the storage area CA. In an embodiment, the input circuit 131 may be implemented using a buffer, a driving circuit, a decoder, etc., which are configured to apply the input data.

The storage area CA may include a plurality of cells forming an array structure.

In an embodiment, each cell may be referred to as a ‘processing element (PE)’. Each of the plurality of cells may perform a multiply-accumulate (MAC) operation on the input data and weight data. In an embodiment, the storage area CA may store the weight data. The weight data may be converted into a weight array to be stored in the storage area CA.

The output circuit 132 may output the result of the operation on the storage area CA as final result data. In an embodiment, the output circuit 132 may be implemented using a buffer, a driving circuit, a decoder, etc. configured to output the final result data.

Unlike the embodiment illustrated in FIG. 2, the operating component 130 may further include a weight buffer which inputs weight data to the storage area CA according to an embodiment. Further, in an embodiment, the input circuit 131 and the output circuit 132 may be implemented as a single component which performs an input function and an output function.

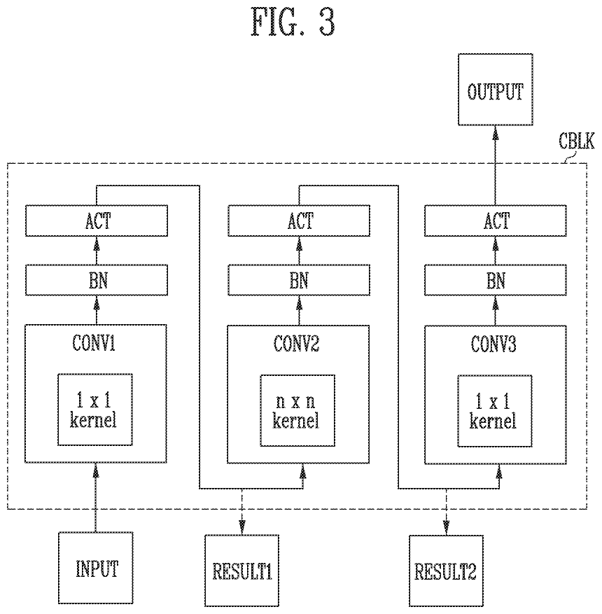

FIG. 3 is a diagram illustrating a convolution block CBLK according to an embodiment of the present disclosure.

Referring to FIG. 3, the convolution block CBLK may include a first convolution layer CONV1, a second convolution layer CONV2, and a third convolution layer CONV3.

In an embodiment, the convolution block CBLK may receive input data INPUT, and may perform a convolution operation on the input data INPUT using the first convolution layer CONV1, the second convolution layer CONV2, and the third convolution layer CONV3. The convolution block CBLK may output final result data OUTPUT as a result of the convolution operation.

The convolution operation may be performed in the order of the first convolution layer CONV1, the second convolution layer CONV2, and the third convolution layer CONV3.

In an embodiment, data that is input to each of the first convolution layer CONV1, the second convolution layer CONV2, and the third convolution layer CONV3 or data that is output therefrom may be referred to as a “feature map.”

The first convolution layer CONV1 may receive the input data INPUT. In an embodiment, the first convolution layer CONV1 may output first result data RESULT1 by performing a convolution operation on the input data

INPUT based on a kernel of 1×1 size (1×1 kernel). In an embodiment, the first convolution layer CONV1 may perform a point-wise convolution operation.

The second convolution layer CONV2 may receive the first result data RESULT1 from the first convolution layer CONV1. In an embodiment, the second convolution layer CONV2 may output second result data RESULT2 by performing a standard convolution operation on the first result data RESULT1. The standard convolution operation may be an operation of performing convolution operations on respective channels of input data based on a kernel of n×n size, where n is a natural number of 2 or greater, and summing the result values of the convolution operations on the respective channels.

The third convolution layer CONV3 may receive the second result data RESULT2 from the second convolution layer CONV2. In an embodiment, the third convolution layer CONV3 may output the final result data OUTPUT by performing a convolution operation on the second result data RESULT2 based on a kernel of 1×1 size (1×1 kernel). In an embodiment, the third convolution layer CONV3 may perform a point-wise convolution operation.

In an embodiment, the convolution block CBLK may further include batch normalization layers BN and activation layers ACT.

For example, a batch normalization layer BN and an activation layer ACT may be located after each of the first convolution layer CONV1, the second convolution CONV2, and the third convolution layer CONV3 in the operation order thereof.

In an embodiment, batch normalization may refer to an operation of performing normalization using an average and a covariance for each batch unit even if pieces of data have various distributions for respective batch units. The batch normalization layer BN may refer to a layer which performs batch normalization.

The activation layer ACT may be a layer which converts a weighted sum of the input data into result data using an activation function. For example, the activation layer ACT may use a Rectified Linear Unit (ReLU) function to output 0 when the input data is less than 0 and to output the input data without change when the input data is greater than 0.

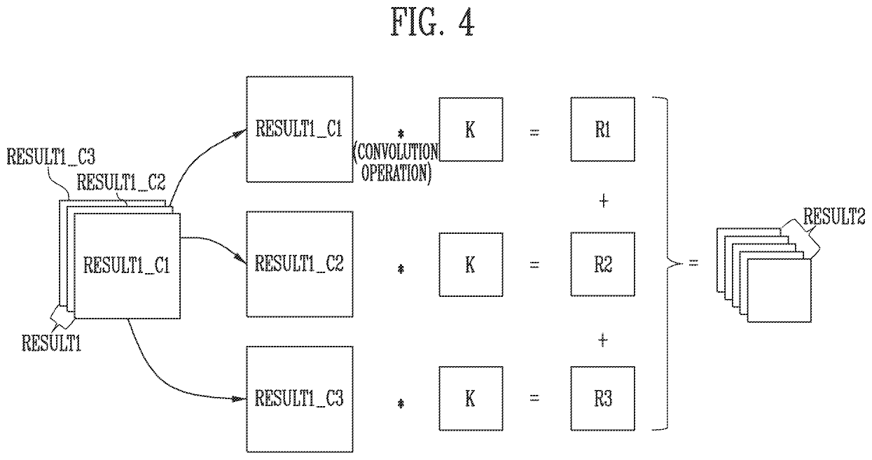

FIG. 4 is a diagram illustrating a convolution operation in a second convolution layer according to an embodiment of the present disclosure.

Referring to FIG. 4, the second convolution layer CONV2 may receive first result data RESULT1 having three channels.

In an embodiment, the second convolution layer CONV2 may perform a convolution operation on each of a first channel RESULT1_C1 of the first result data RESULT1, a second channel RESULT1_C2 of the first result data RESULT1, and a third channel RESULT1_C3 of the first result data RESULT1 based on a kernel K.

The second convolution layer CONV2 may output second result data RESULT2 by summing result values R1, R2, and R3 of the convolution operations on respective channels of the first result data RESULT1.

The convolution operation in the second convolution layer CONV2 may be a standard convolution operation, and may refer to an operation of performing convolution operations on respective channels of the first result data RESULT1 and summing the results R1, R2, and R3 of the convolution operations.

Accordingly, the second convolution layer CONV2 performs the standard convolution operation, thus increasing cell utilization of the storage area CA in which the weight data is stored.

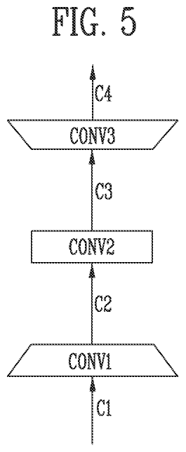

FIG. 5 is a diagram illustrating a bottleneck structure according to an embodiment of the present disclosure.

Referring to FIG. 5, a convolution block may be formed in a bottleneck structure in which a first convolution layer CONV1, a second convolution layer CONV2, and a third convolution layer CONV3 are sequentially located.

In an embodiment, the first convolution layer CONV1 and the third convolution layer CONV3 may perform a point-wise convolution operation.

In an embodiment, the first convolution layer CONV1 may perform a convolution operation so that the number of channels of input data is reduced. In detail, referring to FIG. 3, the first convolution layer CONV1 may perform the convolution operation on the input data INPUT so that the number of channels of the first result data RESULT1 becomes less than the number of channels of the input data INPUT. For example, when data input to the first convolution layer CONV1 has C1 channels, the first convolution layer CONV1 may reduce the number of channels of data to C2 less than C1. That is, the first convolution layer CONV1 may perform the convolution operation so that the number of channels of data input to the second convolution layer CONV2 is reduced.

In an embodiment, the third convolution layer CONV3 may perform a convolution operation so that the number of channels of input data is increased. In detail, referring to FIG. 3, the third convolution layer CONV3 may perform the convolution operation on the second result data RESULT2 so that the number of channels of the final result data OUTPUT becomes greater than the number of channels of the second result data RESULT2. For example, when data input to the third convolution layer CONV3 has C3 channels, the third convolution layer CONV3 may increase the number of channels of data to C4 greater than C3. That is, the third convolution layer CONV3 may perform the convolution operation so that the number of channels of data output from the second convolution layer CONV2 is increased.

Accordingly, the computing system 100 may adjust the number of channels of the data that is input to the second convolution layer CONV2 or the number of channels of the data that is output from the second convolution layer CONV2 by using the first convolution layer CONV1 and the third convolution layer CONV3.

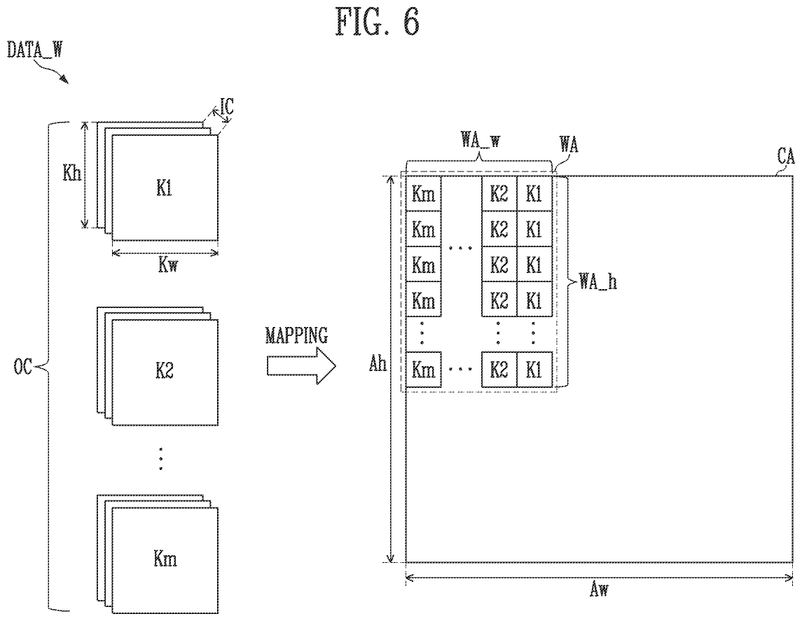

FIG. 6 is a diagram illustrating an operation of mapping weight data according to an embodiment of the present disclosure. In an embodiment, the storage area CA illustrated in FIG. 6 may be configured to process a convolution operation in a second convolution layer CONV2.

Referring to FIG. 6, weight data DATA_W may be mapped to a weight array WA. The mapped weight array WA may be stored in the storage area CA. Elements forming the weight array WA may respectively correspond to cells in the storage area CA.

The number of rows Ah of the storage area CA may denote the height of the storage area CA. The number of columns Aw of the storage area CA may denote the width of the storage area CA.

In an embodiment, the weight data DATA_W may be represented by a plurality of kernels K1 to Km having a plurality of channels. The plurality of kernels K1 to Km may be applied to a convolution operation in the second convolution layer CONV2. The number of channels of each of the kernels K1 to Km may be identical to the number of channels IC of input data. Further, the number of kernel types may be identical to the number of channels OC of output data.

In an embodiment, the number of rows WA_h of the weight array WA may be calculated by multiplying the number of channels IC of input data by the n×n size of each kernel. The number of rows WA_h of the weight array WA may denote the height of the weight array WA.

For example, the number of rows WA_h of the weight array WA may be calculated using the following Equation (1):

$$WA\_h = Kh \times Kw \times IC \qquad ( 1 )$$

In Equation (1), WA_h may denote the number of rows of the weight array WA, Kh may denote the height of each kernel, Kw may denote the width of each kernel, and IC may denote the number of channels of the input data.

In an embodiment, the number of columns of the weight array WA may correspond to the number of channels OC of the output data. The number of columns WA_w of the weight array WA may denote the width of the weight array WA.

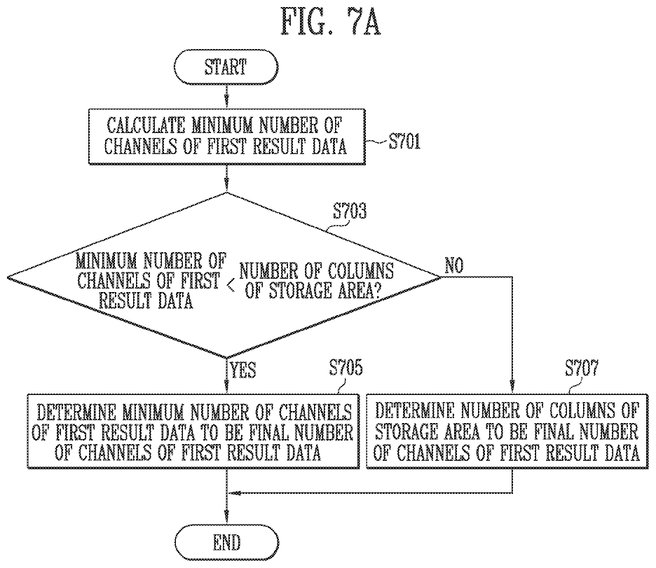

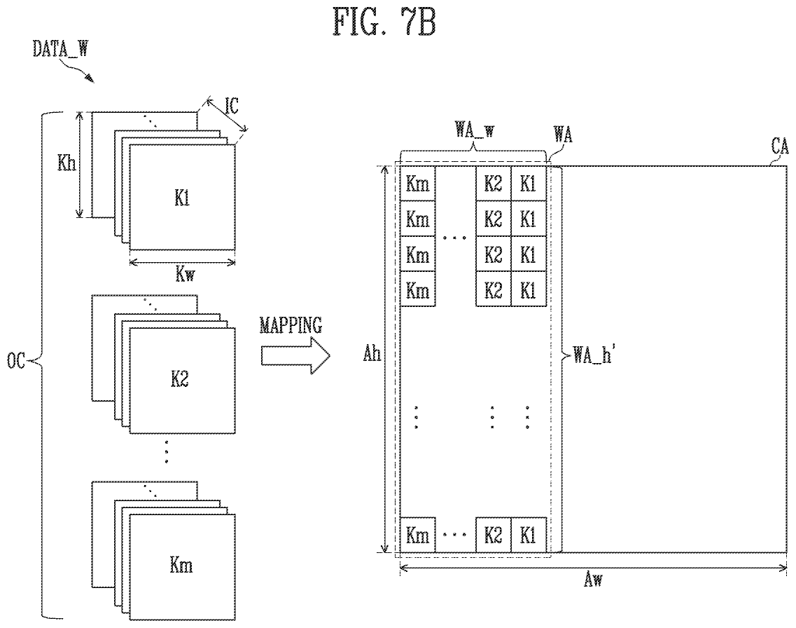

FIG. 7A is a flowchart illustrating a method of determining the number of channels of first result data according to an embodiment of the present disclosure. FIG. 7B is a diagram illustrating an operation of mapping weight data based on the determined number of channels of the first result data according to an embodiment of the present disclosure.

The method illustrated in FIG. 7A may be performed by, for example, the controller 140 illustrated in FIG. 1. In an embodiment, the controller 140 may determine the number of channels of the first result data so that the number of rows WA_h′ of a weight array WA is identical to the number of rows Ah of a storage area CA.

At operation S701, the controller 140 may calculate the minimum number of channels IC_MIN of the first result data. The minimum number of channels IC_MIN of the first result data may be calculated as a value obtained by dividing the number of rows Ah of the storage area CA by the size of each kernel applied to a second convolution layer CONV2.

For example, the minimum number of channels IC_MIN of the first result data may be calculated using the following Equation (2):

$$IC\_MIN = ceil ( Ah \div ( Kh \times Kw ) ) \qquad ( 2 )$$

In Equation (2), IC_MIN may be the minimum number of channels of the first result data, Ah may be the number of rows of the storage area CA, and ceil may be a function of rounding up after a decimal point.

In an embodiment, the controller 140 may determine the lesser value of the minimum number of channels IC_MIN of the first result data and the number of columns Aw of the storage area CA to be the final number of channels IC′ of the first result data. The reason for using the number of columns Aw of the storage area CA as the target of comparison is to consider the number of channels of data output from the first convolution layer CONV1 that is previously operated.

At operation S703, the controller 140 may determine whether the minimum number of channels IC_MIN of the first result data is less than the number of columns Aw of the storage area CA.

When the minimum number of channels IC_MIN of the first result data is less than the number of columns Aw of the storage area CA (i.e., in case of YES in the operation S703), the controller 140 may determine the minimum number of channels IC_MIN of the first result data to be the final number of channels IC′ of the first result data (at operation S705).

When the minimum number of channels IC_MIN of the first result data is equal to or greater than the number of columns Aw of the storage area CA (i.e., in case of NO in the operation S703), the controller 140 may determine the number of columns Aw of the storage area CA to be the final number of channels IC′ of the first result data (at operation S707).

In an embodiment, the controller 140 may set the number of channels of the first result data so that the number of channels of the first result data becomes the final number of channels IC′ using the first convolution layer CONV1 that is capable of adjusting the number of channels.

In an embodiment, the number of rows WA_h′ of the weight array WA may be calculated by multiplying the final number of channels IC′ of the first result data by the size of the kernel. Accordingly, the number of rows WA_h′ of the weight array WA may be identical to the number of rows Ah of the storage area CA.

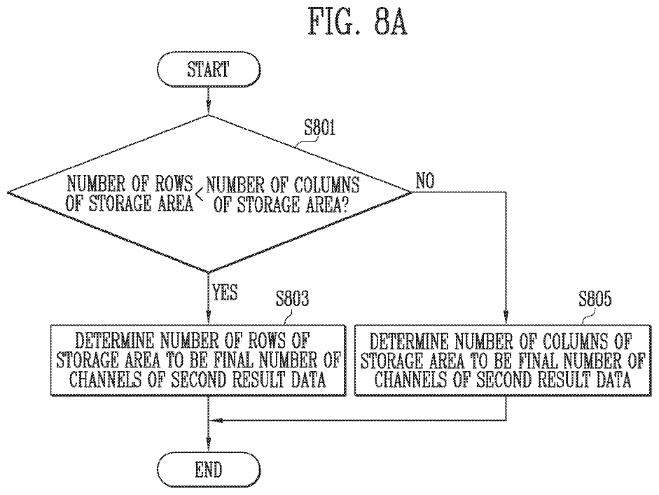

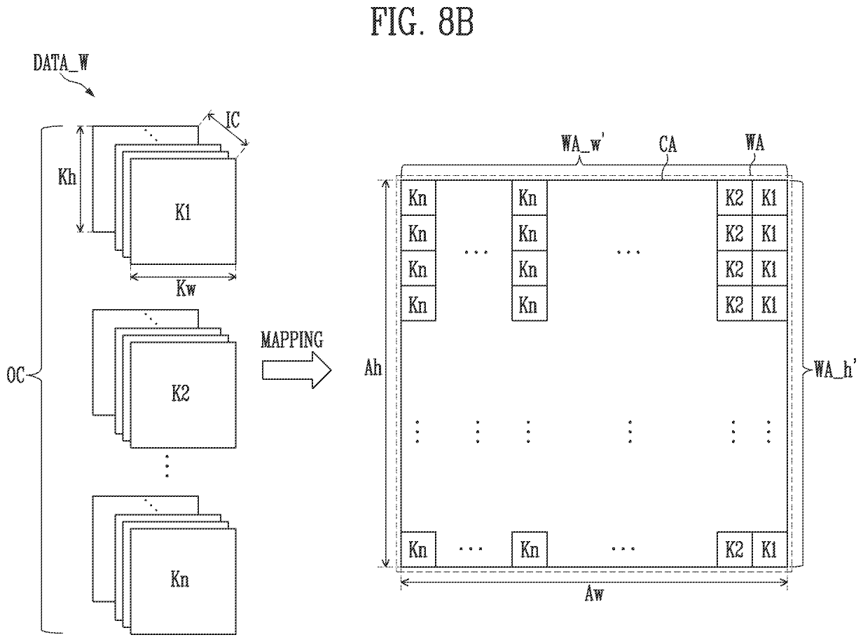

FIG. 8A is a flowchart illustrating a method of determining the number of channels of second result data according to an embodiment of the present disclosure. FIG. 8B is a diagram illustrating an operation of mapping weight data based on the determined number of channels of the second result data according to an embodiment of the present disclosure.

The method illustrated in FIG. 8A may be performed by, for example, the controller 140 illustrated in FIG. 1. In an embodiment, the controller 140 may determine the number of channels in the second result data so that the number of columns WA_w′ of the weight array WA is identical to the number of columns Aw of the storage area CA.

In an embodiment, the controller 140 may determine the lesser value of the number of rows Ah of the storage area CA and the number of columns Aw of the storage area CA to be the number of channels of the second result data. The reason for using the number of rows Ah of the storage area CA as the target of comparison is to consider the number of channels of data input to a third convolution layer CONV3 that is subsequently operated.

At operation S801, the controller 140 may determine whether the number of rows Ah of the storage area CA is less than the number of columns Aw of the storage area CA.

When the number of rows Ah of the storage area CA is less than the number of columns Aw of the storage area CA (i.e., in case of YES in the operation S801), the controller 140 may determine the number of rows Ah of the storage area CA to be the final number of channels OC′ of the second result data (at operation S803).

When the number of rows Ah of the storage area CA is equal to or greater than the number of columns Aw of the storage area CA (i.e., in case of NO in the operation S801), the controller 140 may determine the number of columns Aw of the storage area CA to be the final number of channels OC′ of the second result data (at operation S805).

In an embodiment, the controller 140 may set the number of channels of the second result data so that the number of channels of the second result data becomes the final number of channels OC′ by adjusting the kernel type of the second convolution layer CONV2.

In an embodiment, the number of columns WA_w′ of the weight array WA may correspond to the final number of channels OC′ of the second result data. Accordingly, the number of columns WA_w′ of the weight array WA may be identical to the number of columns Aw of the storage area CA.

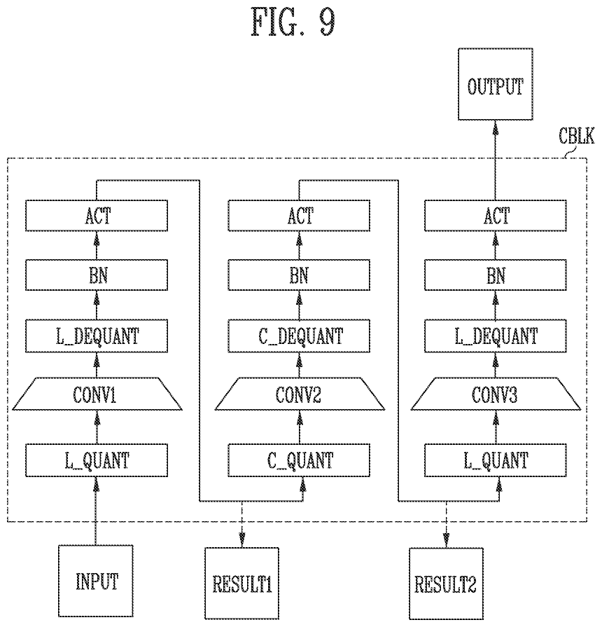

FIG. 9 is a diagram illustrating a quantization operation according to an embodiment of the present disclosure.

Referring to FIG. 9, the controller 140 may perform a quantization operation on each of a first convolution layer CONV1, a second convolution layer CONV2, and a third convolution layer CONV3 included in a convolution block CBLK. Here, the quantization operation may be a process of converting a real number-type variable into an integer-type variable and may reduce the size of a neural network model and enhance a processing speed.

In an embodiment, the controller 140 may perform a channel-wise quantization operation on the second convolution layer CONV2. The channel-wise quantization operation may be an operation of performing quantization for each channel. For example, a convolution block CBLK may include a channel-wise quantization layer C_QUANT and a channel-wise dequantization layer C_DEQUANT before and after the second convolution layer CONV2. The channel-wise quantization layer C_QUANT may perform channel-wise quantization on the input data of the second convolution layer CONV2. Further, the channel-wise dequantization layer C_DEQUANT may perform channel-wise dequantization on the result data of the second convolution layer CONV2. Dequantization may be an operation of changing back quantized data into the form of an original variable.

In an embodiment, the controller 140 may perform a layer-wise quantization operation on each of the first convolution layer CONV1 and the third convolution layer CONV3. The layer-wise quantization operation may be an operation of performing quantization for each layer. For example, the convolution block CBLK may include a layer-wise quantization layer L_QUANT and a layer-wise dequantization layer L_DEQUANT before and after each of the first convolution layer CONV1 and the third convolution layer CONV3. The layer-wise quantization layers L_QUANT may perform layer-wise quantization on pieces of input data of the first convolution layer CONV1 and the third convolution layer CONV3, respectively. Furthermore, the layer-wise dequantization layers L_DEQUANT may perform layer-wise dequantization on pieces of result data of the first convolution layer CONV1 and the third convolution layer CONV3, respectively.

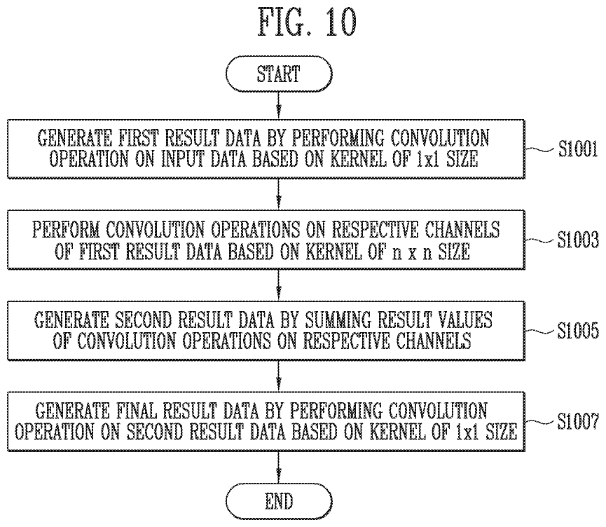

FIG. 10 is a flowchart illustrating a method of operating a computing system according to an embodiment of the present disclosure.

The method illustrated in FIG. 10 may be performed by, for example, the computing system 100 illustrated in FIG. 1.

Referring to FIG. 10, at operation S1001, the computing system 100 may generate first result data having a channel of a first size by performing a convolution operation on input data based on a kernel of 1×1 size through a first convolution layer.

In an embodiment, the computing system 100 may perform the convolution operation so that the first size becomes smaller than the size of the channel of the input data.

In an embodiment, the first size may be determined to be the lesser value of a value, obtained by dividing the number of rows of a storage area on which the convolution operation is performed by n×n size, and the number of columns of the storage area.

In an embodiment, channel-wise quantization may be performed on the first result data.

At operation S1003, the computing system 100 may perform convolution operations on respective channels of the first result data based on a kernel of n×n size through a second convolution layer.

At operation S1005, the computing system 100 may generate second result data having a channel of a second size by summing result values of the convolution operations on the respective channels through the second convolution layer.

In an embodiment, the second size may be determined to be the lesser value of the number of rows of the storage area on which the convolution operation is performed and the number of columns of the storage area.

At operation S1007, the computing system 100 may generate final result data by performing a convolution operation on the second result data based on a kernel of 1×1 size through a third convolution layer.

In an embodiment, the computing system 100 may perform the convolution operation so that the size of the channel of the result data becomes greater than the second size.

According to the present disclosure, there are provided a computing system having improved neural network processing performance and a method of operating the computing system.

While the present disclosure has been shown and described with reference to certain embodiments thereof, it will be understood by those skilled in the art that various changes in form and details may be made therein without departing from the scope of the present disclosure and any equivalents. Therefore, the scope of the present disclosure should not be limited to the above-described embodiments but should include the equivalents thereof.

In the above-described embodiments, all operations may be selectively performed or part of the operations may be omitted. In each embodiment, the operations are not necessarily performed in accordance with the described order and may be rearranged. The embodiments disclosed in this specification and drawings are only examples to facilitate an understanding of the present disclosure, and the present disclosure is not limited thereto. That is, it should be apparent to those skilled in the art that various modifications can be made on the basis of the technological scope of the present disclosure.

The embodiments of the present disclosure have been described in the drawings and specification. Although specific terminologies are used here, those are only to describe the embodiments of the present disclosure. Therefore, the present disclosure is not restricted to the above-described embodiments and many variations are possible within the scope of the present disclosure. It should be apparent to those skilled in the art that various modifications can be made on the basis of the technological scope of the present disclosure in addition to the embodiments disclosed herein. Furthermore, the embodiments may be combined to form additional embodiments.

What is claimed is:

1. A computing system comprising:
an operating component including at least one convolution block configured to perform convolution operations on input data based on weight data to generate final result data; and
a controller configured to control the operating component to perform the convolution operations,
wherein the at least one convolution block comprises:
a first convolution layer configured to perform a first convolution operation on the input data based on a kernel of 1×1 size to generate first result data;
a second convolution layer configured to perform second convolution operations on respective channels of the first result data based on a kernel of n×n size, and sum result values of the convolution operations on the respective channels of the first result data to generate second result data, where n is a natural number of 2 or greater; and
a third convolution layer configured to perform a third convolution operation on the second result data based on the kernel of the 1×1 size to generate the final result data.

2. The computing system according to claim 1, wherein the at least one convolution block further comprises:
a batch normalization layer; and
an activation layer.

3. The computing system according to claim 1, wherein the at least one convolution block is formed in a bottleneck structure in which the first convolution layer, the second convolution layer, and the third convolution layer are sequentially located.

4. The computing system according to claim 3, wherein, according to the first convolution operation, a number of channels of the first result data becomes less than a number of channels of the input data.

5. The computing system according to claim 3, wherein, according to the third convolution operations, a number of channels of the final result data becomes greater than a number of channels of the second result data.

6. The computing system according to claim 1, wherein each of the first convolution operation and the third convolution operation includes a point-wise convolution operation.

7. The computing system according to claim 1, wherein the operating component further includes a storage area in which a plurality of cells storing a weight array corresponding to the weight data are formed in an array structure.

8. The computing system according to claim 7, wherein the controller is configured to determine a number of channels of the first result data so that a number of rows of the weight array is equal to a number of rows of the storage area.

9. The computing system according to claim 8, wherein the controller is configured to determine, as the number of channels of the first result data, a lesser value of a value, obtained by dividing the number of rows of the storage area by the n×n size, and a number of columns of the storage area.

10. The computing system according to claim 8, wherein the number of rows of the weight array is calculated by multiplying the number of channels of the first result data by the n×n size.

11. The computing system according to claim 7, wherein the controller is configured to determine a number of channels of the second result data so that a number of columns of the weight array is equal to a number of columns of the storage area.

12. The computing system according to claim 11, wherein the controller is configured to determine, as the number of channels of the second result data, a lesser value of a number of rows of the storage area and a number of columns of the storage area.

13. The computing system according to claim 1, wherein the controller is configured to perform a channel-wise quantization operation on the second convolution layer.

14. The computing system according to claim 1, wherein the controller is configured to perform a layer-wise quantization operation on each of the first convolution layer and the third convolution layer.

15. A method of operating a computing system for processing a convolution block including a plurality of convolution layers, the method comprising:
performing, by a first convolution layer among the plurality of convolution layers, a first convolution operation on input data based on a kernel of 1×1 size to generate a first result data having a channel of a first size;
performing, by a second convolution layer among the plurality of convolution layers, second convolution operations on respective channels of the first result data based on a kernel of n×n size, where n is a natural number of 2 or greater;
summing, by the second convolution layer, result values of the second convolution operations on the respective channels in the second convolution layer to generate second result data having a channel of a second size; and
performing, by a third convolution layer among the plurality of convolution layers, a third convolution operation on the second result data based on the kernel of the 1×1 size to generate final result data.

16. The method according to claim 15, wherein:
resulting from the performing the first convolution operation, the first size becomes smaller than a size of a channel of the input data, and
resulting from the performing the third convolution operation, a size of a channel of the final result data becomes greater than the second size.

17. The method according to claim 15, wherein the first size is determined to be a lesser value of a value, obtained by dividing a number of rows of a storage area on which the first convolution operation is performed by the n×n size, and a number of columns of the storage area.

18. The method according to claim 15, wherein the second size is determined to be a lesser value of a number of rows of a storage area on which the second convolution operations are performed and a number of columns of the storage area.

19. The method according to claim 15, further comprising, before performing the second convolution operations on the respective channels of the first result data, performing a channel-wise quantization operation on the first result data.
